(19) United States
(12) Patent Application Publication
(10) Pub. No.: US 2004/0117342 A1
(43) Pub. Date: Jun. 17, 2004

(54) Method and device for acquisition and transmission of data by means of the post input and optionally post output particular for po boxes

(76) Inventor: Christoph Plato, Nurnberg (DE)

Correspondence Address: John F Hoffman, Baker & Daniels, Suite 800, 111 East Wayne Street, Fort Wayne, IN, 46802, US

(21) Appl. No.: 10/474,099

(22) PCT Filed: Mar. 27, 2002
(86) PCT No.: PCT/DE02/01119

(30) Foreign Application Priority Data
Apr. 6, 2001 (DE) 101-17-458.6

(51) Int. Cl. G06F 7/00

(52) U.S. Cl. 707/1

(57) ABSTRACT

The invention relates to a method and a device for acquiring and transmitting data via the inbox and if appropriate the outbox, in particular with mailboxes, which transmit the data from a central postal collection area to the recipient/s via public access telecommunications channels (mobile or fixed network telephone, cable, satellite etc.) manually or automatically triggered. The advantage for the user consists particularly in the savings in time and effort, which offers a considerable cost advantage.

The invention relates to a method and a device for acquiring and transmitting data via the inbox and if appropriate the outbox, in particular with mailboxes, in accordance with the generic term of the independent patent claims.

Such methods and devices are not known from the state of the art.

Against the background of the termination of the existing letter transport monopoly of the German Post Office it is predictable that mail transport, in particular in the more remote corners of the Federal Republic of Germany will no longer take place without further ado, i.e. without adjusting the logistics to a standard price.

After the termination of the letter transport monopoly of the German Post Office it is thus to be assumed that mail transport in the more remote corners of the Federal Republic of Germany will no longer take place without further ado, that is, without adjusting the logistics to a standard price. Not so perhaps in the densely populated areas. A standard price is however an essential prerequisite for the acceptance of the service of “mail transport” on the mass market. According to newspaper reports, the volume of mail continues to increase.

Presumably the installation of central mailboxes/depots and the self-pickup of the mail by the recipient in relevant areas will represent a realistic solution at least with standard items and contribute to the maintenance of relatively low mail transport fees.

The “missing link” of this transportation chain is the notification of the mail recipient about the arrival of an item.

Other applications of the invention's method and device should also be encompassed in full extent by the present invention, such as e.g. data acquisition and communication of the inbox and if appropriate the outbox with lockers at train stations, airports, gas stations, banks etc. pigeonholes, individual mailboxes of houses and apartments, supermarket collection boxes e.g. with telephone order or e-commerce by Internet with pickup after store closing, postal outboxes at offices such as townships, License Bureaus, Building Authorities, District Offices etc. or with postal outbox of pharmacies and hospitals and large medical practices. The areas of use of the present invention are thus numerous and manifold and currently not yet to be foreseen in their entirety.

It is the object of the present invention to make available a method and a device which makes possible independent acquisition and communication of data via the inbox and if appropriate the outbox and information about the postal item, in particular with mailboxes, quickly, simply and cost-advantageously.

The technical teaching of the independent patent claims serves to solve the tasks.

It is a basic feature here that by means of the method and device for acquiring and transmitting data via the inbox and if appropriate the outbox, particularly with mailboxes, data are first acquired via at least the inbox in at least one postal collection area by means of suitable sensors and after that these data are made available at least in part for the query of at least one recipient and/or are sent to at least one recipient, whereby the data transfer is performed via at least one public or public access telecommunications channel.

The advantage here is that the invention's method saves the recipient unnecessary legwork in order to check whether any mail has come for him in his assigned (mail) box and is ready to be picked up. This brings both an advantage in time as well as a financial advantage for the recipient himself, as well as for the national economy.

Thus the advantage for the user consists in particular in the legwork (time) savings.

If the modified logistics includes the installation/setup of central mailboxes/collection points and self pickup of the mail by the recipient (North America) in order to keep the mail transport payment at a relatively low marketable level, an automatic or semi-automatic notification of the mail recipient about the arrival of an item of the chain promises to close the chain.

This notification is preferably carried out by sending SMS (short message service) via the mobile radio network, so that the recipient is not locally fixated, but rather can continuously receive the message from the inbox. Of course other are also possible, such as e.g. by telephone via fixed network (call or fax), by telephone or PC via the Internet, via BTX, VTX, UMTS, GSM, GPS, cable (television broadband distribution network), or radio or the like.

The message via the inbox or if necessary the outbox from the collection box at a central collection area along with differentiation by number also makes possible a differentiation by type and urgency of the postal item, or even via physical parameters such as e.g. weight, dimensions etc.

The more users who were connected to collection mailbox units at central points (post offices or independent from them) the lower the expenditure would be for hardware installation for each individual user.

The sending of the message can be triggered manually by input on the part of the delivery person, automatically mechanically (electrical contacts) or automatically contact-less (transponder, photosensor assemblies, inductive/capacitive sensors, bar code) or semi-automatically, but intelligently (bar code recording and to a large extent sender and detail information forwarding via SMS).

Depending on its design, either the delivery person (to avoid abuse), regardless of which mail transport company the delivery person belongs to, can trigger the (SMS) message manually (or by bar code scanning) and hereby if necessary differentiate according to the contents (advertisement/newspapers/regular mail/special delivery letters . . . ), whereby this can also take place automatically by means of the mail slot itself.

The “intelligent” automatic form of notification can—manually or bar code supported or otherwise—imply the transport of information differentiated by type, urgency, sender and other detail information of the postal item (=essential, optional comfort criterion, that ensures the future capacity of the innovation).

The marketing opportunity consists particularly in the provision of the transmission facility (loan, leasing, purchase) and provision of the airtime (telephone fees) for forwarding an SMS or other message form.

Collective transmission facilities are also conceivable: The more users who are connected to group mailbox units at central points (post offices or independent from them) the lower the expenditure would be for hardware installation of the device for information transmission for each individual user.

Mobile radio network supported notification is predestined for service in the more remote corners.

On the recipient side—provided no mobile end device yet exists—this generates an additional need. The receiving device can through intelligent forwarding and via corresponding interfaces be any other networked device.

The application possibilities do not extend only to group mailboxes, but rather also to individual mailboxes. That is, the application possibilities exist already today. SMS notification via the inbox is ideal, in the case of absence due to vacation, for replacing a person or saving the person who regularly checks the inbox unnecessary legwork.

The triggering of the transmission of the stored data can take place manually by a person (recipient and/or mail carrier), or automatically in dependency on the exceeding or falling below of data values or parameters. The triggering can for example occur on the exceeding of a date, a weight of the postal item, a size dimension of the postal item or of an exterior event (e.g. notification of a third party).

The invention thus relates to a method and a device for information transmission of data of the inbox and if necessary of the outbox, in particular with mailboxes which transmit the data from a central postal collection area to the recipient/s via public access telecommunications channels (mobile or fixed network telephone, cable, satellite etc.) manually or automatically triggered. The advantage for the user consists particularly in the savings in time and effort, which offers a considerable cost advantage.

1. Method for acquiring and transmitting data via the inbox and if appropriate the outbox, in particular with mailboxes, characterized by the fact that data are first acquired via at least the inbox in at least one postal collection area by means of suitable means and after that these acquired data are made available at least in part for the query of at least one recipient and/or are sent to at least one recipient, whereby the data transfer is performed via at least one public or public access telecommunications channel.

2. Method according to claim 1, characterized by the fact that data are also acquired and made available and/or transmitted via the outbox.

3. Method according to one of claims 1 or 2, characterized by the fact that the data are sent to several recipients and/or made available for several recipients.

4. Method according to one of claims 1 through 3, characterized by the fact that the data of several postal collection areas are acquired and transmitted or made available for pickup.

5. Method according to one of claims 1 through 4, characterized by the fact that the suitable means for acquiring the data are contacting and/or non-contacting sensors.

6. Method according to claim 5, characterized by the fact that the suitable means for acquiring the data contain bar code readers and/or transponders and/or photosensor assemblies and/or optical recording devices (also analog and digital photo and motion-picture cameras).

7. Method according to one of claims 1 through 5, characterized by the fact that the suitable means for acquiring the data are formed by a human being who acquires said data manually and/or via at least one public or public access telecommunications channel.

8. Method according to one of claims 1 through 7, characterized by the fact that the acquired data are made available in an appropriate internal data storage chip (IC) in the postal collection area.

9. Method according to one of claims 1 through 8, characterized by the fact that the acquired data are made available in an appropriate external data storage chip (IC) in an external database.

10. Method according to one of claims 1 through 9, characterized by the fact that the data can be transmitted and/or received terrestrially via telephone line and/or cable and/or via air interface by means of radio channels and/or via satellite

11. Method according to one of claims 1 through 10, characterized by the fact that the data can be transmitted and/or received via fixed network telephone and/or mobile telephone and/or computer and/or television equipment.

12. Method according to one of claims 1 through 11, characterized by the fact that the data can be transferred via the Internet.

13. Method according to one of claims 1 through 12, characterized by the fact that the data can be transferred as e-mail.

14. Method according to one of claims 1 through 13, characterized by the fact that the data contain text and/or graphics and/or acoustic data.

15. Method according to claim 14, characterized by the fact that the data contain SMS data (short message service).

16. Method according to one of claims 1 through 15, characterized by the fact that the data contain information about the inbox and if appropriate the outbox number of items and/or weight information and/or dimensional information and/or dates (in/out) and/or sender/recipient data and/or classifications by content and/or priority specifications and/or declarations of value and/or information about the postal collection areas.

17. Device for acquiring and transmitting data via the Inbox and if appropriate the outbox, in particular with mailboxes, said device works according to one of claims 1 through 16, characterized by the fact that the device contains:
a) at least one container at/in at least one postal collection area
b) at least one suitable access opening in the container,
c) suitable means for acquiring the data via the inbox and if appropriate the outbox,
d) suitable means for making available and/or for sending the data via the inbox and if necessary outbox to at least one recipient,

18. Device according to claim 17, characterized by the fact that the suitable means for acquiring the data via the inbox and if appropriate the outbox are non-contacting and/or contacting sensors.

19. Device according to claim 18, characterized by the fact that the non-contacting sensors contain bar code readers and/or transponders.

20 Device according to one of claims 17 through 19, characterized by the fact that the suitable means for making available and/or for sending the data via the inbox and if appropriate the outbox to at least one recipient contain internal and/or external data storage units.

21. Device according to one of claims 17 through 20, characterized by the fact that the suitable means for sending the data offers access to public or public access telecommunications channels/networks.

22. Device according to claim 21, characterized by the fact that the suitable means for sending the data offers access to at least one telephone network (fixed/mobile) and/or a cable network (television-broadband distribution network) and/or a radio channel network and/or a satellite network.
